(19) United States
(12) Patent Application Publication
(10) Pub. No.: US 2010/0024736 A1
(43) Pub. Date: Feb. 4, 2010

(54) FOOD HOUSE FOR SMALL ANIMALS

(76) Inventor: Paul Davis, Bedford, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/184,749

(22) Filed: Aug. 1, 2008

(51) Int. Cl. A01K 1/10

(52) U.S. Cl. 119/51.11; 119/51.5; 119/52.4

(57) ABSTRACT

A device, system, and method for an animal food house are disclosed herein. The present invention house is for small animals and includes a housing. The front section of the housing may have a vertical opening and a protruding barrier. This protruding barrier overhangs and blocks a portion of the vertical opening and may preventing large animals from observing or accessing the vertical opening. The food house may have a transparent window on at least one of the side sections of the housing. There may also be a food opening and a water opening on the top section of the housing for providing nutrients to the animal. A feeding tube extends through the food opening into the housing and a water holder extends through the water opening into the housing.

### TECHNICAL FIELD

The present invention relates to animal feeders in general and more particularly, relates to a pet-feeding house for any small animal that prevents medium to large animals from entering the house.

### BACKGROUND INFORMATION

There are some animal houses available today that provide shelter from the outside elements as well as a place to sleep. In addition, there are a number of food dispensers that can distribute various animal foods (dry and wet) and water. The animal house and the food dispensers provide two different objectives and are typically located separate from each other. Therefore, there is a need for an animal house that utilizes various food dispensers inside the house. Additionally, there is also a need for an animal house that is configured to only allow smaller animals into the house. This need has arisen from the tendency of dogs to eat another animal's food such as cat food.

Therefore, what is needed is a shelter that has dispensers for continuously distributing food and water to small pets, while physically preventing medium to large pets from gaining access to the shelter and food.

### SUMMARY

The present invention is a food house for small animals including a housing that has a front section, a back section, two side sections, and a top section. The front section of the housing further includes a vertical opening and a protruding barrier. This protruding barrier overhangs and blocks a portion of the vertical opening thereby preventing larger animals from observing or accessing the vertical opening. The food house may have a transparent window on at least one of the side sections. There may also be a food opening and a water opening on the top section of the housing. A feeding tube may extend through the food opening into the housing. There may also be a water holder that extends through the water opening into the housing.

An exemplary embodiment of the present invention may include a barrier with about a 45-degree angle. Another embodiment of the present invention may include a barrier that only allows an access space with a height between 6 to 12 inches from the ground to an edge of the barrier. A further embodiment includes a timing mechanism on the top section of the housing for dispensing an amount of food over time.

Another exemplary embodiment includes a food dish disposed at a distal end of the feeding tube in relation to the food opening. The food dish may be detachable from the housing by one or more magnets embedded in a side of the food dish. There may be corresponding magnets in the housing to connect with the magnets embedded in the food dish. This food dish may have a further embodiment of being constructed at a specific angle so that the deepest section of the dish is located farthest from the feeding tube.

A further exemplary embodiment may have a water dish disposed at a distal end of the water holder in relation to the water opening. This exemplary embodiment also includes a disbursing water system located along the water holder and directly above the water dish.

The present invention is not intended to be limited to a system or method that must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a perspective view of a small animal feeding device according to the present invention;

FIG. 2 is a backside view of the small animal feeding device according to the present invention;

FIG. 3 is an inside view of a small animal feeding device according to the present invention;

FIG. 4A is a cross-sectional view of the food disbursement mechanism according to the present invention;

FIG. 4B is a detailed cross-sectional view of the food disbursement mechanism of FIG. 4A;

FIG. 5A is a cross-sectional view of the water disbursement mechanism according to the present invention; and

FIG. 5B is a cross-sectional view of the water dish, water bottle holder, and water bottle according to the present invention.

### DETAILED DESCRIPTION OF THE PREFERRED EMBODIMENTS

The present invention is a continuous feeding system for small animals, such as cats, rabbits, guinea pigs, and the like, while restricting medium to large animals, such as dogs, from access to this system. This system allows a user to provide small animals with continuous access to food and water without interruption or depletion by larger animals. The present invention physically restricts medium to large animals from access to the feeding system.

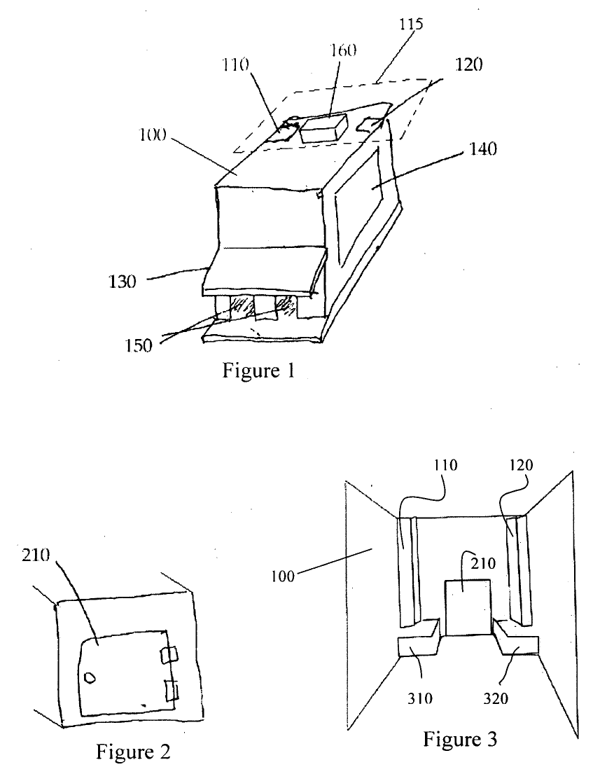

As shown in FIGS. 1 and 2, the present invention generally includes a housing 100, food and water dispensing mechanisms 115, a narrow vertical opening 150, a protruding barrier 130, a transparent viewing panel 140, and an access panel 210. The housing 100 is preferably made from either injection-molded plastic or wood. The housing 100 is a body that is generally hollow. A combination of narrow vertical openings 150 and a protruding barrier 130 act as physical deterrents to medium and large animals from entering the housing 100. The vertical openings 150 are too narrow for medium to large animals, most specifically dogs, to enter beyond their shoulders. The protruding barrier 130 further prevents medium and large animals from getting their heads stuck in the narrow vertical openings 150 by physically preventing the animal from getting close to the vertical openings 150. This protruding barrier 130 is preferably angled at about 45 degrees and allows an access space with a height between 6 to 15 inches and more preferably 8 inches from the ground to an edge of the protruding barrier 130.

A transparent window 140, preferably made from a scratch resistant plastic, provides light for the pet so that it feels safe when entering the housing 100. This window 140 further enables the pet to be able to see the food and water as well as allowing a pet owner to monitor the pets and food/water levels. The housing 100 has a feeding tube 110 and a water bottle holder 120 built into the unit. The housing may also contain a timing mechanism 160 for dispensing food portions over time. The access panel 210, FIGS. 2 and 3, enables a user to access the inside of the house for cleaning the interior, refilling the food container or water container, providing the pet with blankets/pillows, etc.

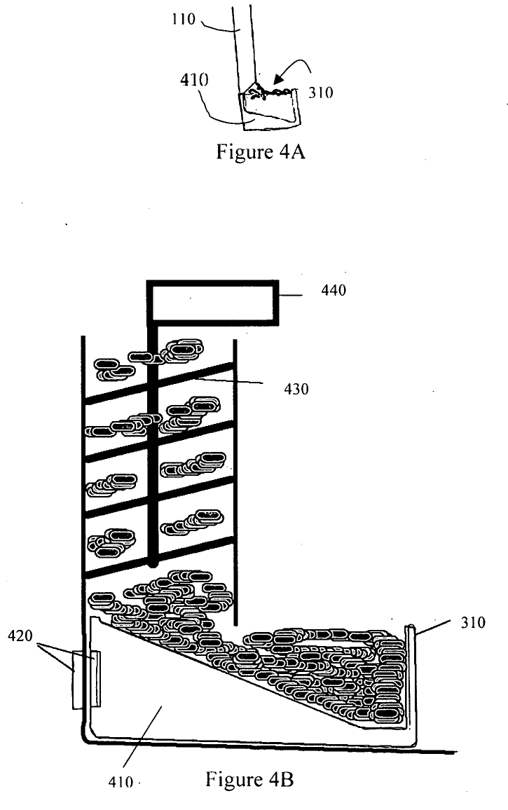

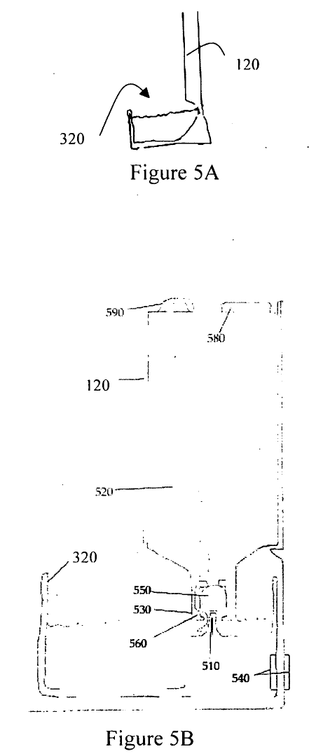

Referring to FIGS. 1 and 3, the continuous feeding mechanism 115 consists of a feeding tube 110 and a food dish 310. The feeding tube 110 may hold several portions of food and is built into the housing unit 100. As shown in FIG. 4A, the base of the food dish 410 is fabricated at an angle, with the deepest part of the dish furthest away from the feeding tube 110. This angle allows gravity to pull a continuous supply of food into the dish. Therefore, the feeding tube 110 continuously supplies food to the pet by filling the food dish 310 and replenishing the dish as food is consumed. When the food dish 310 is full, the food in the dish blocks more food from dropping out of the feeding tube 110. As the pet eats the food, gravity pulls more food out of the feeding tube 110 and replenishes the food dish 310.

As shown in FIG. 4B, the food dish 310 is preferably detachable and secured in a correct position by magnets 420 that are embedded in the side of the dish 310 and are aligned to corresponding magnets 420 in the wall of the housing 100. The magnets 420 allow the pet owner to detach the food dish from the housing 100 and wash it separately. FIG. 4B also depicts a preferred feeding control mechanism based on an auger device 430 that is controlled by an electrical motor 440 that turns the auger and dispenses the food at set intervals determined by the customer using the timer mechanism 160 that is attached to the top of the main body 100.

Referring to FIGS. 5A and 5B, the water disbursement mechanism is comprised of a bottle holder 120, a water dish 320, and a removable bottle 520. The bottle holder 120 is a hollow frame built into the main housing 100. The owner may insert the bottle 520 in an upside down position inside the holder 120 such that a raised pin 510 that protrudes from inside the water dish 320 enters the mouth of the bottle 530 and forces a plastic ball 550 upward into the neck of the bottle, thereby exposing the drain valves 560. When exposed, the drain valves release water by action of gravity until the water level reaches the mouth of the water bottle. When the pet drinks enough water so that the water level drops below the mouth of the water bottle 530, air enters the bottle causing the bottle to release water and refill the dish 320. When the bottle 520 is empty, the user can remove the bottle by lifting on a finger handle 590, pull it from the bottle holder 120, and refill it with the screw off cap 580 at the opposite end of the bottle mouth 530. After the bottle is refilled, the user places the bottle 520 back into the bottle holder 120 in an upside down position. When the mouth of the bottle is in the down position, the plastic ball 550 blocks the mouth and prevents water from leaking. The water dish 120 is detachable by magnets 540 that are embedded in the side of the dish 120 and are aligned to corresponding magnets 540 in the wall of the housing 100. The magnets allow the pet owner to detach the water dish and wash it separately.

Modifications and substitutions by one of ordinary skill in the art are considered to be within the scope of the present invention, which is not to be limited except by the following claims.

The invention claimed is:

1. A food house for small animals comprising:
a housing having a front section, a back section, two side sections, and a top section, said housing further having a vertical opening and a protruding barrier on said front section wherein said protruding barrier overhangs and blocks a portion of said vertical opening whereby larger animals are prevented access to said vertical opening;
a transparent window on at least one of said side sections;
a food opening on said top section;
a feeding tube extending through said food opening into said housing;
a water opening on said top section; and
a water holder extending through said water opening into said housing.

2. The food house of claim 1, wherein said barrier is angled at about 45 degrees and only allows an access space with a height of about 8 inches from the ground to an edge of said barrier.

3. The food house of claim 1, wherein said barrier only allows an access space with a height of between 6 to 12 inches from the ground to an edge of said barrier.

4. The food house of claim 2, wherein said transparent window is made from a scratch resistant plastic.

5. The food house of claim 2 further comprising a timing mechanism on said top section for dispensing an amount of food over time.

6. A food house for small animals comprising:
a housing having a front section, a back section, two side sections, and a top section, said housing further having a vertical opening and a protruding barrier on said front section wherein said protruding barrier overhangs and blocks a portion of said vertical opening whereby larger animals are prevented access to said vertical opening;
a transparent window on at least one of said side sections;
a food opening on said top section;
a feeding tube extending from said food opening into said housing;
a water opening on said top section;
a water holder extending from said water opening into said housing; and
a food dish disposed at a distal end of said feeding tube in relation to said food opening, said food dish is detachable from said housing by a plurality of magnets embedded in a side of said food dish, said housing has a plurality of corresponding magnets to connect with said magnets embedded in said food dish.

7. The food house of claim 6, wherein said food dish has a base that is constructed at a specific angle whereby a deepest section of said dish is farthest from said feeding tube.

8. The food house of claim 7, wherein said barrier is angled at about 45 degrees and only allows an access space with a height of about 8 inches from the ground to an edge of said barrier.

9. The food house of claim 7, wherein said barrier only allows an access space with a height of between 6 to 12 inches from the ground to an edge of said barrier.

10. The food house of claim 8, wherein said transparent window is made from a scratch resistant plastic.

11. The food house of claim 10 further comprising a timing mechanism on said top section for dispensing an amount of food over time.

12. A food house for small animals comprising:
a housing having a front section, a back section, two side sections, and a top section, said housing further having a vertical opening and a protruding barrier on said front section wherein said protruding barrier overhangs and blocks a portion of said vertical opening and said protruding barrier extends from above said vertical opening and extends out and downward whereby larger animals are visually obstructed from said vertical opening;
a transparent window on at least one of said side sections;
a food opening on said top section;
a feeding tube extending from said food opening into said housing;
a water opening on said top section;
a water holder extending from said water opening into said housing;
a food dish disposed at a distal end of said feeding tube in relation to said food opening;
a water dish disposed at a distal end of said water holder in relation to said water opening; and
a means for disbursing water located along said water holder and directly above said water dish.

13. The food house of claim 12, wherein said means for disbursing water comprises:
a removable bottle that is placed upside down within said water holder, said bottle has a mouth section;
a raised pin that protrudes from inside said water dish into said mouth section;
a plastic ball located within said mouth section;
a plurality of drain valves located within said mouth section closest to said raised pin, said plastic ball and said drain valves are forced by gravity until water reaches said mouth section of said removable bottle;
a finger handle on a surface of an opposite end from said mouth section; and
a screw off cap on said surface at said opposite end from said mouth section.

14. The food house of claim 13, wherein said water dish is detachable from said housing by a plurality of magnets embedded in a side of said water dish, said housing has a plurality of corresponding magnets to connect with said magnets embedded in said water dish.

15. The food house of claim 14, wherein said food dish is detachable from said housing by a plurality of magnets embedded in a side of said food dish, said housing has a plurality of corresponding magnets to connect with said magnets embedded in said food dish.

16. The food house of claim 15, wherein said food dish has a base that is constructed at a specific angle whereby a deepest section of said dish is farthest from said feeding tube.

17. The food house of claim 16, wherein said barrier is angled at about 45 degrees and only allows an access space with a height of about 8 inches from the ground to an edge of said barrier and extends outward a distance of about 6 inches.

18. The food house of claim 16, wherein said barrier only allows an access space with a height of between 6 to 15 inches from the ground to an edge of said barrier.

19. The food house of claim 17, wherein said transparent window is made from a scratch resistant plastic.

20. The food house of claim 19 further comprising a timing mechanism on said top section for dispensing an amount of food over time.
